(19) United States
(12) Patent Application Publication
(10) Pub. No.: US 2012/0113151 A1
(43) Pub. Date: May 10, 2012

(54) DISPLAY APPARATUS AND DISPLAY METHOD

(76) Inventor: Shinichi NAKANO, Osaka (JP)

(21) Appl. No.: 13/290,162

(22) Filed: Nov. 7, 2011

(30) Foreign Application Priority Data
Nov. 8, 2010 (JP) 2010-250000

(51) Int. Cl. G06F 3/041; G09G 5/00

(52) U.S. Cl. 345/682; 345/173; 345/156

(57) ABSTRACT

A position specification accepting section accepts a position specification on a display screen of a display section, and a display position accepting section accepts from a user a specification of a display position of an instruction acceptance image for accepting an instruction concerning to display of an image via the position specification accepting section. A display control section causes the display section to display the instruction acceptance image at the to display position concerning the specification accepted by the display position accepting section from the user.

### CROSS-REFERENCE TO RELATED APPLICATIONS

This Nonprovisional application claims priority under 35 U.S.C. §119(a) on Patent Application No. 2010-250000 filed in Japan on Nov. 8, 2010, the entire contents of which are hereby incorporated by reference.

### BACKGROUND

1. Technical Field

The present invention relates to a display apparatus and a display method which displays, on a display section, an instruction acceptance image for accepting an instruction concerning display of an image to be displayed on the display section.

2. Description of Related Art

In recent years, a display apparatus comprising a touch panel becomes widely used, and a display section has been enlarged, thereby the display apparatus also has been enlarged.

However, there is an operational inconvenient problem that the touch panel has an area where a user cannot reach in a large-sized display apparatus having a height and a width exceeding a body height of a human being.

As opposed to the problem, Japanese Patent Application Laid-Open No. 2009-198734 discloses a multi display apparatus which comprises a master display apparatus and a slave display apparatus, in which the master display apparatus and the slave display apparatus are connected to each other and a manipulated input is limited to the master display apparatus, and thereby a presenter's spatial movement is reduced, and switching of a display screen of the slave display apparatus, edit of the displayed data, etc. can be performed easily and intuitively.

### SUMMARY

However, the above-described multi display apparatus disclosed in Japanese Patent Application Laid-Open No. 2009-198734 needs a complicated configuration in which the master display apparatus and the slave display apparatus are provided all together.

The present invention has been made with the aim of solving the above problems, and it is an object of the invention to provide a display apparatus and a display method which accepts a specification of a display position of an instruction acceptance image for accepting an instruction concerning display of an image via a position specification accepting section for accepting a position specification on a display screen of a display section, and displays the instruction acceptance image on the display position, thereby resolving an operational inconvenience in accordance with enlargement thereof with simple constitution and enhancing the operational convenience of a user.

The display apparatus according to the present invention is a display apparatus, comprising: a display section for displaying an image; a display control section for causing the display section to display an instruction acceptance image for accepting an instruction concerning display of the image; a position specification accepting section for accepting a position specification on a display screen of the display section; and a display position accepting section for accepting a specification of a display position of the instruction acceptance image via the position specification accepting section.

The display method according to the present invention is a display method with a display apparatus comprising: a display section for displaying an image; a display control section for causing the display section to display an instruction acceptance image for accepting an instruction concerning display of the image; and a position specification accepting section for accepting a position specification on a display screen of the display section, the display method for displaying the instruction acceptance image, comprising: a display position acceptance step for accepting a specification of a display position of the instruction acceptance image via the position specification accepting section; and a step for causing the display section to display the instruction acceptance image by the display control section, based on the display position accepted at the display position acceptance step.

In the present invention, the display position accepting section accepts a specification of a display position of the instruction acceptance image via the position specification accepting section. The display control section causes the display section to display the instruction acceptance image at a display position concerning the specification accepted by the display position accepting section.

The display apparatus according to the present invention is characterized in that the display control section causes the display section to display one or a plurality of instruction acceptance images.

In the present invention, the display control section causes the display section to display the instruction acceptance image at a display position concerning the specification accepted by the display position accepting section. Moreover, when the display position accepting section accepts other specification, the display control section causes the display section to display another instruction acceptance image at other display position concerning said other specification accepted by the display position accepting section.

The display apparatus according to the present invention is characterized in that the position specification accepting section accepts a position specification in a predetermined area on the display screen of the display section, and the display control section causes the display section to display the instruction acceptance image in the predetermined area.

In the present invention, the position specification accepting section can accept a position specification in partially predetermined area of the display screen of the display section, for example. The display control section causes the display section to display the instruction acceptance image in the predetermined area of the display screen.

The display apparatus according to the present invention is characterized by further comprising an area changing section for changing the predetermined area.

In the present invention, the area changing section changes the predetermined area, and the display control section causes the display section to display the instruction acceptance image in the changed predetermined area.

The display apparatus according to the present invention is characterized by further comprising a notifying section for notifying information indicating the predetermined area.

In the present invention, the notifying section notifies information indicating the predetermined area. Therefore, even if the predetermined area is changed, for example, a user can recognize the position after changing.

The display apparatus according to the present invention is characterized by further comprising an image pickup section for picking up an image in front of the display section, wherein based on the image picked up by the image pickup section, the display control section causes the display section to display the instruction acceptance image.

In the present invention, the display control section causes the display section to display the instruction acceptance image at a predetermined position of the display section with a predetermined method, based on the image picked up by the image pickup section.

The display apparatus according to the present invention is characterized by further comprising a body detecting section for detecting a position of a specific body part of a user, based on the image picked up by the image pickup section, wherein the display control section changes the display position of the instruction acceptance image, based on a detection result of the body detecting section.

In the present invention, the body detecting section detects a position of a user's specific body part (for example, a face, a shoulder, an upper body, etc.), based on the image picked up by the image pickup section. The display control section changes the display position of the instruction acceptance image to a position corresponding to the position of the specific body part of the user, based on a detection result of the body detecting section.

The display apparatus according to the present invention is characterized by further comprising a characteristics detecting section for detecting physical characteristics of a user, based on the image picked up by the image pickup section, wherein the display control section changes a constitution of the instruction acceptance image, based on a detection result of the characteristics detecting section.

In the present invention, the characteristics detecting section detects a user's physical characteristics (for example, age, sex, etc.), based on the image picked up by the image pickup section. The display control section changes a constitution (for example, a font size, a background color, etc.) of the instruction acceptance image, based on a detection result of the characteristics detecting section.

The display apparatus according to the present invention is characterized by further comprising a judging section for judging existence of a user in a predetermined area based on the image picked up by the image pickup section, wherein the display control section causes the display section to display the instruction acceptance image based on a judgment result of the judging section.

In the present invention, the judging section judges existence of a user in a predetermined area in front of the display section based on the image picked up by the image pickup section. For example, when the judging section judges that the user is in the predetermined area, the display control section causes the display section to display the instruction acceptance image, and when the judging section judges that the user is not in the predetermined area, said display control section causes the display section to delete the displayed instruction acceptance image.

The display apparatus according to the present invention is characterized in that the body detecting section detects a position of a specific body part of a user at a predetermined time interval.

In the present invention, the body detecting section repeatedly detects a position of a user's specific body part at a predetermined time interval. Each time the body detecting section detects the position, the display control section changes a display position of the instruction acceptance image according to a detection result of the body detecting section, and thereby it is possible to respond to changing of a user's position.

The display apparatus according to the present invention is characterized by further comprising an area changing section for changing the predetermined area, wherein the area changing section changes a predetermined area of the display screen of the display section, based on a detection result of the body detecting section.

In the present invention, the body detecting section repeatedly detects a position of a user's specific body part at a predetermined time interval. Each time the body detecting section detects the position, the area changing section changes the predetermined area on the display screen of the display section according to a detection result of the body detecting section.

The display apparatus according to the present invention is characterized in that the display section includes a plurality of sub-display sections, and a part of the sub-display sections has the position specification accepting section.

In the present invention, the display section comprises a plurality of sub-display sections, and a part of sub-display sections has the position specification accepting section. The position specification accepting section accepts a position specification in partially predetermined sub-display section.

According to the present invention, operational inconvenience occurring in the display apparatus in accordance with enlargement thereof can be solved with simpler constitution, and the operational convenience of a user can be enhanced.

The above and further objects and features will more fully be apparent from the following detailed description with accompanying drawings.

### BRIEF DESCRIPTION OF THE SEVERAL VIEWS OF THE DRAWINGS

FIG. 1 is a functional block diagram showing essential configurations of a large-sized display apparatus according to Embodiment 1 of the present invention.

FIG. 2 is an exemplary view showing a display example of a control window in the large-sized display apparatus according to Embodiment 1 of the present invention.

FIG. 3 is an exemplary view showing a display example of a control window in the large-sized display apparatus according to Embodiment 1 of the present invention.

FIG. 4 is an exemplary view showing a display example of a control window in the large-sized display apparatus according to Embodiment 1 of the present invention.

FIG. 5 is a functional block diagram showing essential configurations of a large-sized display apparatus according to Embodiment 2 of the present invention.

FIG. 6 is an explanatory diagram for explaining a predetermined area on the X-axis concerning judgment by a judging section of the large-sized display apparatus according to Embodiment 2 of the present invention.

FIG. 7 is an exemplary view showing an example of a window constitution table stored in a storage section of the large-sized display apparatus according to Embodiment 2 of the present invention.

FIG. 8 is a schematic view showing schematically an appearance of the large-sized display apparatus according to Embodiment 2 of the present invention.

FIG. 9 is an explanatory diagram for explaining a display control of a control window based on a detection result of a body detecting section of the large-sized display apparatus according to Embodiment 2 of the present invention.

FIG. 10 is an explanatory diagram for explaining a display control of a control window based on a detection result of a physical-characteristics detecting section of the large-sized display apparatus according to Embodiment 2 of the present invention.

FIG. 11 is a flow chart for explaining a display process of a control window in the large-sized display apparatus according to Embodiment 2 of the present invention.

FIG. 12 is an explanatory diagram for explaining a display of a control window corresponding to a user's movement in the large-sized display apparatus according to Embodiment 2 of the present invention.

FIG. 13 is a functional block diagram showing essential configurations of a large-sized display apparatus according to Embodiment 2 of the present invention.

FIG. 14 is an explanatory diagram for explaining a configuration of a position specification accepting section of the large-sized display apparatus according to Embodiment 3 of the present invention.

FIG. 15 is an exemplary view showing an example of a changing process of a part, capable of accepting a position specification, of the position specification accepting section of the large-sized display apparatus according to Embodiment 3 of the present invention.

FIG. 16 is an exemplary view for explaining notification in the large-sized display apparatus according to Embodiment 3 of the present invention.

FIG. 17 is a flow chart for explaining a display process of a control window in the large-sized display apparatus according to Embodiment 3 of the present invention.

FIG. 18 is a flow chart for explaining a display process of a control window in the large-sized display apparatus according to Embodiment 3 of the present invention.

FIG. 19 is an exemplary view showing processing results from S201 to S206 in Embodiment 3 of the present invention.

FIG. 20 is an exemplary view showing processing results from S207 to S212 in Embodiment 3 of the present invention.

### DETAILED DESCRIPTION

### Embodiment 1

The Following Description Will Explain an Example in which a display apparatus according to Embodiment 1 of the present invention is applied to a large-sized display apparatus, based on the drawings in detail.

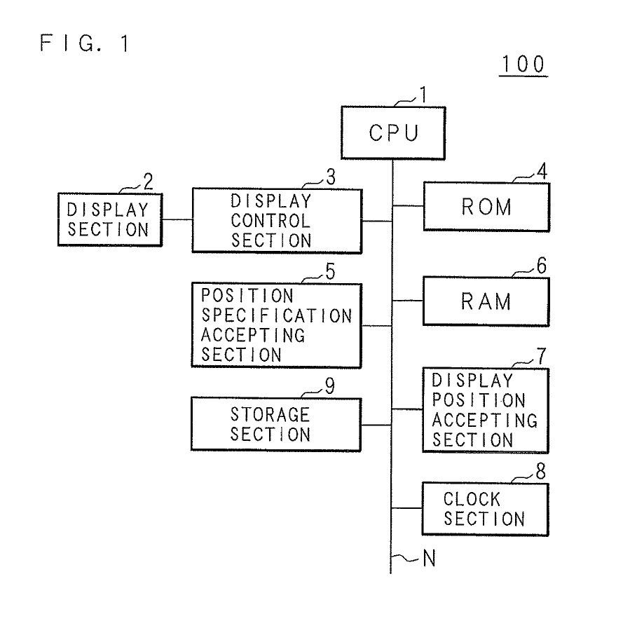

FIG. 1 is a functional block diagram showing essential configurations of a large-sized display apparatus 100 according to Embodiment 1 of the present invention. The large-sized display apparatus 100 comprises a CPU 1, a ROM 4, and a RAM 6.

The ROM 4 stores various kinds of control programs in advance, and the RAM 6 is capable of storing data temporarily and allows the data to be read regardless of the order and place they are stored. The RAM 6 stores, for example, a program read from the ROM 4, various kinds of data generated by the execution of the program and the like.

The CPU 1 controls a later-described various hardware devices via a bus N by loading on the RAM 6 the control program stored in the ROM 4 in advance and executing it, and operates the whole apparatus as the large-sized display apparatus 100 of the present invention.

Moreover, the large-sized display apparatus 100 further comprises: a display section 2 for displaying a control window (instruction acceptance image) which accepts an instruction concerning an image and display of the image; a display control section 3 for controlling display of an image, display of the control window on the display section 2, etc.; a position specification accepting section 5 for accepting a position specification on a display screen of the display section 2 from a user; a display position accepting section 7 for accepting a specification of a display position of the control window from a user; a storage section 9 for storing image data of an image to be displayed on the display section 2; and a clock section 8 for clocking a time course from a predetermined clock time.

The display section 2 is a large-sized LCD monitor, for example, and displays an image and the control window. The control window has a plurality of soft keys for controlling display of an image. For example, the control window has the soft keys, such as “enlargement”, “reduction”, “rotation”, and “deletion”, and the like, and a user operates the control window to control display of an image.

The display control section 3 controls display of an image, display of the control window on the display section 2, and the like. For example, the display control section 3 causes the display section 2 to display an image according to an instruction of the CPU 1, or causes the display section 2 to display one or more control windows based on a specification of a display position of the control window accepted by the display position accepting section 7, and moves the control window.

The position specification accepting section 5 is a so-called touch panel, and is provided so as to cover the display screen of the display section 2. The position specification accepting section 5 accepts a position specification on the display screen of the display section 2 through a user's touch operation. The position specification accepting section 5 senses a change of pressure by a touch operation of a user's fingertip or senses an electric signal by static electricity, and detects coordinates on the display screen of the display section 2 corresponding to a contact point of the user's fingertip, and then generates a signal for identifying the coordinates. The signal for identifying the coordinates corresponding to the position specification accepted by the position specification accepting section 5 is sent to the CPU 1.

The CPU 1 acquires the signal (coordinates) from the position specification accepting section 5, and recognizes that among the soft keys displayed on the display section 2, the soft key located at a position corresponding to the coordinates has been operated. Therefore, the CPU 1 can accept a specification from a user via the position specification accepting section 5.

The display position accepting section 7 monitors the position specification accepting section 5, and accepts a specification of a display position of the control window from a user. When a user performs a predetermined operation (for example, double-touch, long push, etc.), the display position accepting section 7 accepts a position concerning said operation as a specification of a display position of the control window.

The following description will explain display of a control window in the large-sized display apparatus 100 according to Embodiment 1 of the present invention.

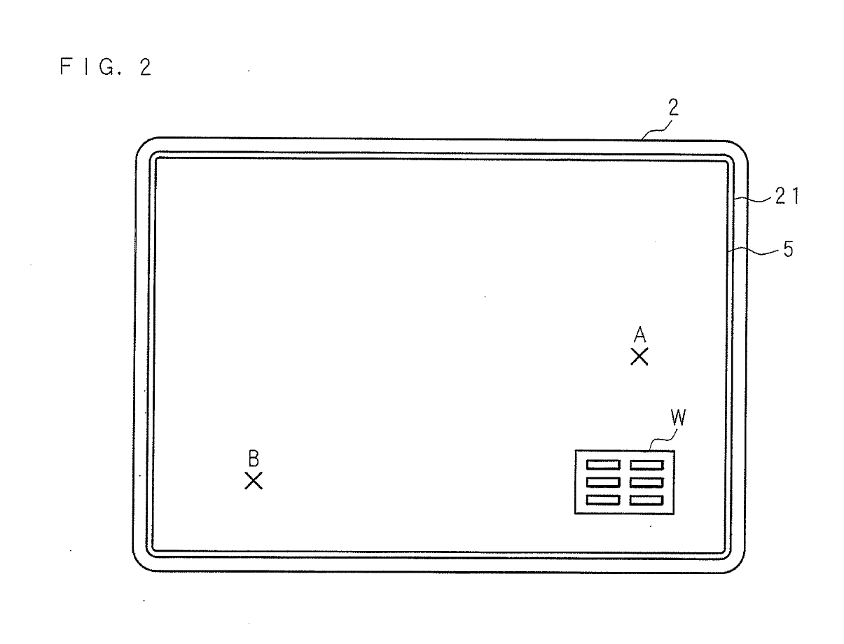

FIGS. 2 through 4 are exemplary views showing a display example of a control window W in the large-sized display apparatus 100 according to Embodiment 1 of the present invention. The position specification accepting section 5 is provided so as to cover a display screen 21 of the display section 2, and the control window W is displayed on the display screen 21. The control window W has a plurality of soft keys for controlling display of an image displayed on the display section 2.

For example, when a user performs the double-touch at the A position of the position specification accepting section 5 within a predetermined time, that is, when the position specification accepting section 5 accepts position specifications of the same position twice within the predetermined time, the display position accepting section 7 accepts the position as a display position for the control window W.

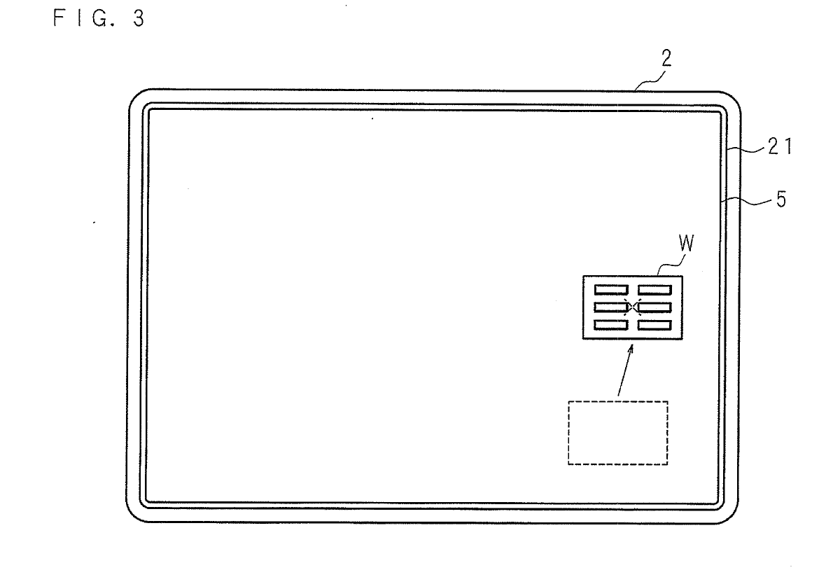

Thus, when the display position accepting section 7 accepts a specification of a display position, the display control section 3 causes the display section 2 to display a control window W at a display position concerning the specification accepted by the display position accepting section 7 and to delete the currently displayed control window W. Therefore, as shown in FIG. 3, it is possible to move the control window W. Note that the present invention is not limited to this, and it may be configured so as to perform a so-called drag operation.

On the other hand, when another user performs the long-press at the B position (refer to FIG. 2) of the position specification accepting section 5 for a predetermined time, that is, when the position specification accepting section 5 accepts position specifications of the same position twice or more within the predetermined time, the display position accepting section 7 accepts the position as a display position of a new control window W.

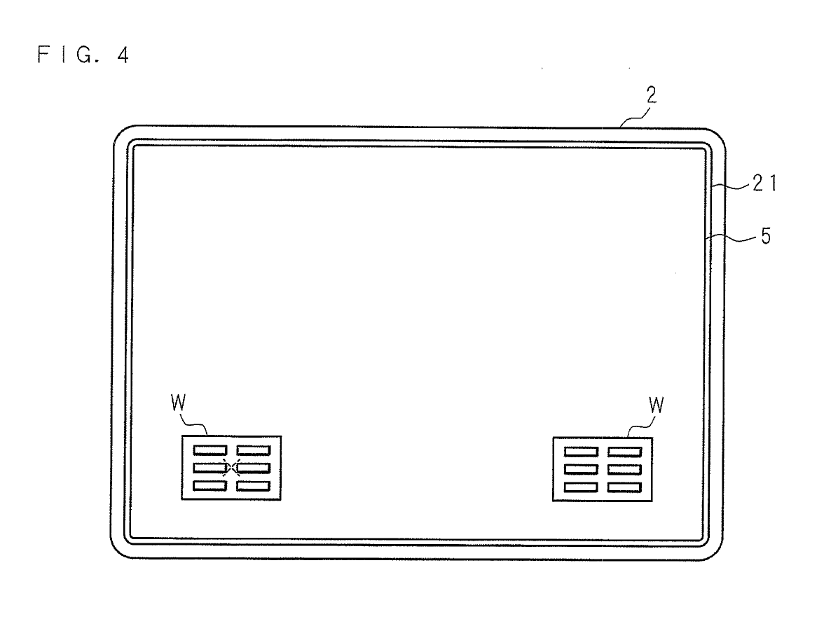

Thus, when the display position accepting section 7 accepts a specification of a display position, the display control section 3 causes the display section 2 to display a new control window W at a display position concerning the specification accepted by the display position accepting section 7. Therefore, as shown in FIG. 4, it is possible to display a plurality of control windows W.

### Embodiment 2

The Following Description Will Explain a Large-Sized Display apparatus 100 according to Embodiment 2 of the present invention, based on the drawings in detail.

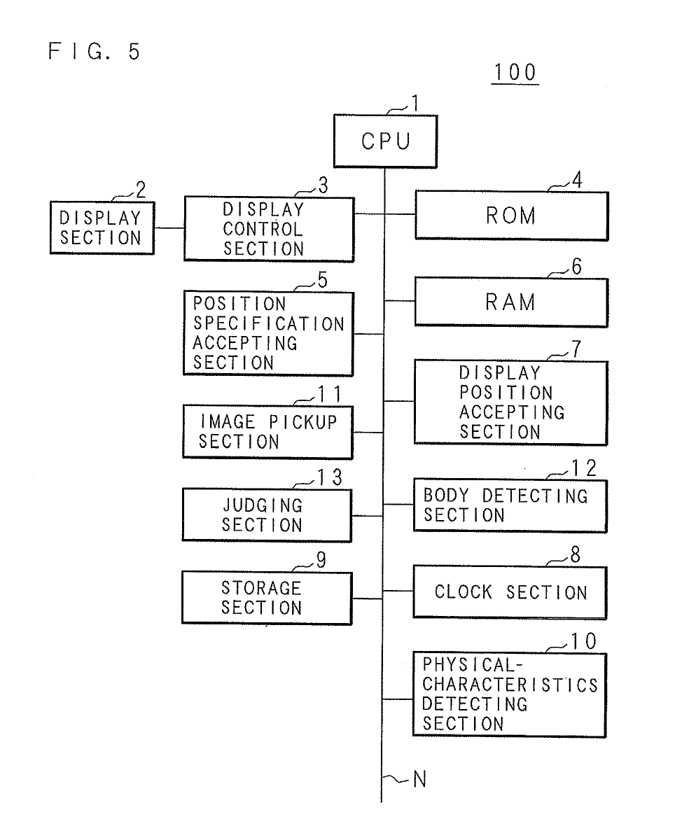

FIG. 5 is a functional block diagram showing essential configurations of the large-sized display apparatus 100 according to Embodiment 2 of the present invention. The large-sized display apparatus 100 according to Embodiment 2 further comprises a physical-characteristics detecting section 10, an image pickup section 11, a body detecting section 12, and a judging section 13, in addition to the large-sized display apparatus 100 according to Embodiment 1.

The image pickup section 11 is provided at a position capable of picking up an image of a body of a user being in front of the display section 2. The existing technique is used for the image pickup section 11. For example, the image pickup section 11 has an image pickup device, such as an image sensor like a CCD (Charge Coupled Device), and creates a picked up image.

Moreover, the image pickup section 11 has a depth-sensing-camera function capable of recognizing a motion, a position, etc. of a user using infrared ray, for example. Therefore, the image pickup section 11 can pick up an image of a user, only when the user is within a predetermined distance from the display section 2.

The body detecting section 12 detects a user's specific body part (for example, face), based on the image picked up by the image pickup section 11, for example. In the present embodiment, the body detecting section 12 performs a process for detecting a face of a human being using the existing technique. For example, the body detecting section 12 detects an area approximate to a skin color from the image picked up by the image pickup section 11, and judges whether or not the detected area includes a pattern with a characteristic shape included in a face of a human being, such as eyes, eyebrows, and a mouth. When the body detecting section 12 judges that the detected area includes the pattern with the characteristic shape, the body detecting section 12 recognizes it as a face and detects a position of the face. Note that the body detecting section 12 is not limited to the detection of a user's face. For example, the body detecting section 12 may be configured so as to detect an upper body, a shoulder, a neck, an eye, etc. of a user.

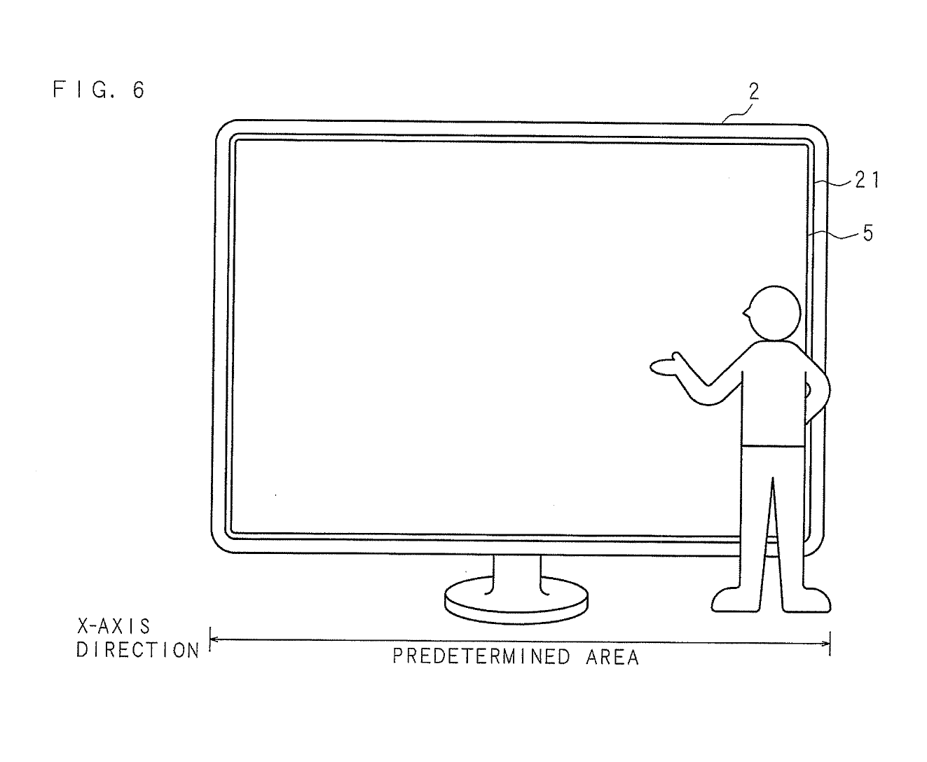

The judging section 13 judges whether or not a user is within a predetermined area located in front of the display section 2 based on the image picked up by the image pickup section 11. For example, as shown in FIG. 6, when a width direction (lateral direction) of the display section 2 is set as the X-axis on the picked up image, the judging section 13 judges whether or not a user is in a predetermined area on the X-axis of the picked up image, based on the image picked up by the image pickup section 11. In other words, since the image pickup section 11 picks up an image of a user only when the user is within the predetermined anterior distance from the display section 2, the judging section 13 judges whether or not a user is within the predetermined anterior distance from the display section 2 and within the predetermined area in the width direction of the display section 2.

The physical-characteristics detecting section 10 detects a user's physical characteristics based on the image picked up by the image pickup section 11. The physical characteristics are age, sex, etc. of a user, for example. The physical-characteristics detecting section 10 recognizes a face of a user through the above-described procedure based on the image picked up by the image pickup section 11, and estimates age, sex, etc. of the user from an outline of a face, or a positional relationship of eyes, eyebrows, a nose, a mouth, etc., or a wrinkling, or sag, etc. of the user.

Moreover, the storage section 9 according to Embodiment 2 stores a window constitution table. The window constitution table includes information for identifying components constituting a control window W (for example, a character font, a softkey size, a background color, etc.).

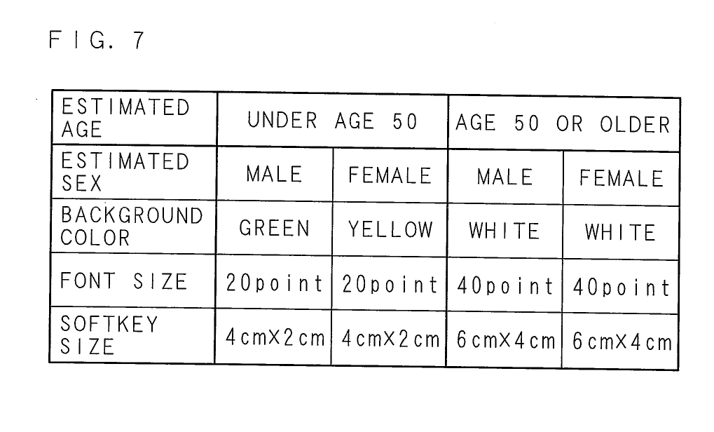

FIG. 7 is an exemplary view showing an example of the window constitution table stored in the storage section 9 of the large-sized display apparatus 100 according to Embodiment 2 of the present invention. The background color, character font, and softkey size of the control window W for each age and each sex are described in the window constitution table.

For example, a soft key and a font size of the control window W referred when it is estimated that a user is aged 50 years or more are set in the window constitution table, so as to be larger than those referred when it is estimated that a user is aged less than 50 years, and thereby a user who is aged 50 years or more and has bad eyesight can operate the large-sized display apparatus 100.

The display control section 3 according to Embodiment 2 causes the display section 2 to display a control window W based on processing results of the judging section 13, the body detecting section 12 and the physical-characteristics detecting section 10. The contents will be explained below in detail.

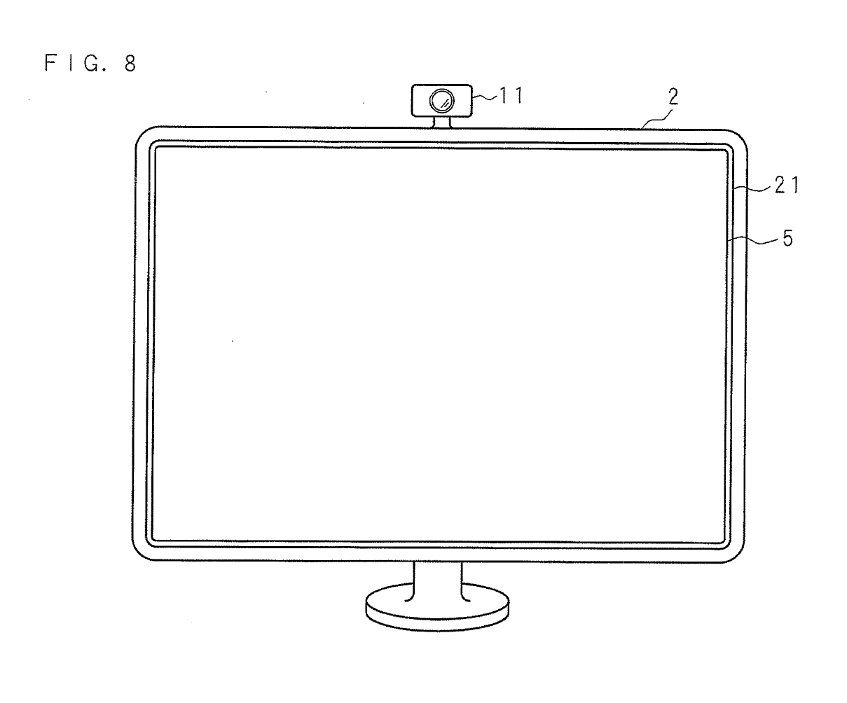

FIG. 8 is a schematic view showing schematically an appearance of the large-sized display apparatus 100 according to Embodiment 2 of the present invention. The large-sized display apparatus 100 according to Embodiment 2 comprises the image pickup section 11 in an upper center of an edge part of the display section 2.

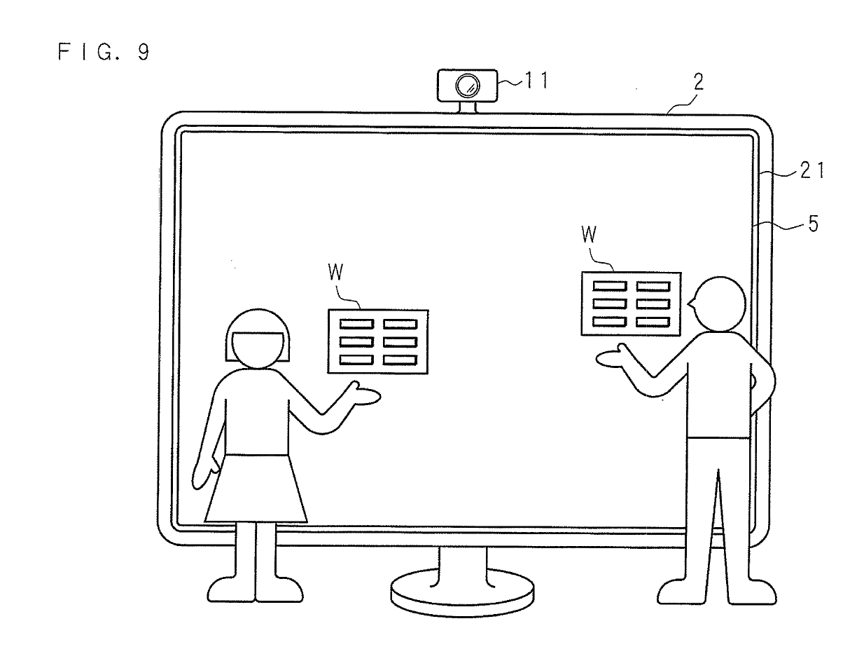

FIG. 9 is an explanatory diagram for explaining a display control of a control window W based on a detection result of the body detecting section 12 of the large-sized display apparatus 100 according to Embodiment 2 of the present invention.

For example, when the body detecting section 12 detects a position of a face of a user based on the image picked up by the image pickup section 11, the display control section 3 causes the display section 2 to display a control window W at a position on the display section 2 corresponding to the position of the user's face detected by the body detecting section 12. That is, regardless of a height of a user and a height of the display section 2, a control window W is displayed at the position corresponding to the position of the user's face on the display section 2. Therefore, even though the display section 2 is large-sized, it is possible to prevent beforehand a disadvantage of an operation due to which a user cannot reach to the control window W, and enhance the convenience of a user at a time of the operation.

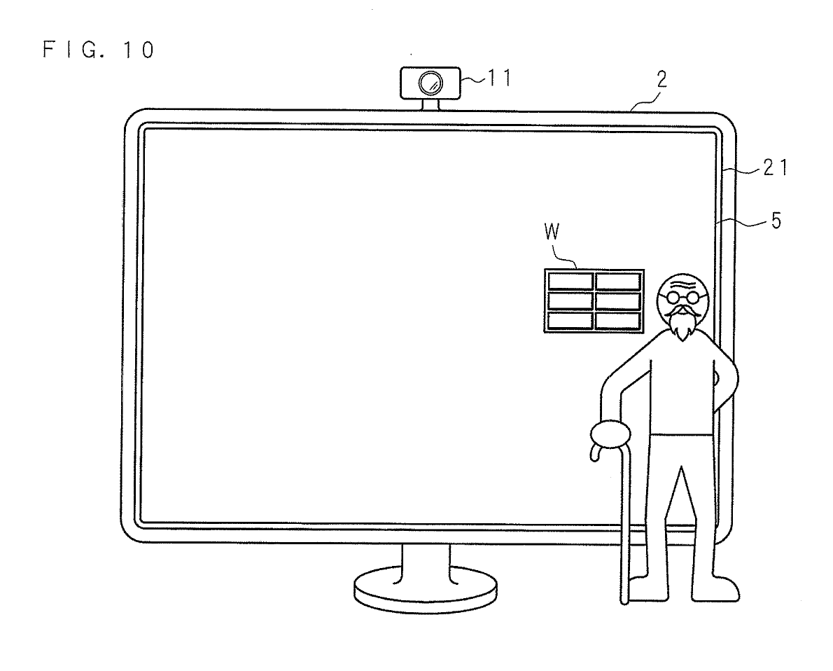

On the other hand, FIG. 10 is an explanatory diagram for explaining a display control of a control window W based on a detection result of the physical-characteristics detecting section 10 of the large-sized display apparatus 100 according to Embodiment 2 of the present invention.

For example, the following description will explain an example in which the physical-characteristics detecting section 10 detects a user's physical characteristics based on the image picked up by the image pickup section 11, and estimates that the user's age is 50 or more and the user's sex is a male. Based on a detection result of the user's physical characteristics by the physical-characteristics detecting section 10, the display control section 3 causes the display section 2 to display a control window W with reference to the window constitution table stored in the storage section 9. That is, since the physical-characteristics detecting section 10 estimates that the user is male aged 50 or more, the display control section 3 causes the display section 2 to display a control window W such that a background color of the control window W is white, a font size is 40 point, and a size of each softkey is 6 cm×4 cm. It can be realized that a size of each softkey of the control window W shown in FIG. 10 is larger than that of the control window W shown in FIG. 9.

Note that when the judging section 13 judges that a user is not within the predetermined anterior distance from the display section 2 and within the predetermined area in the width direction of the display section 2, based on a clocking result of the clock section 8, the display control section 3 causes the display section 2 to delete the displayed control window W after the passage of a predetermined time, for example.

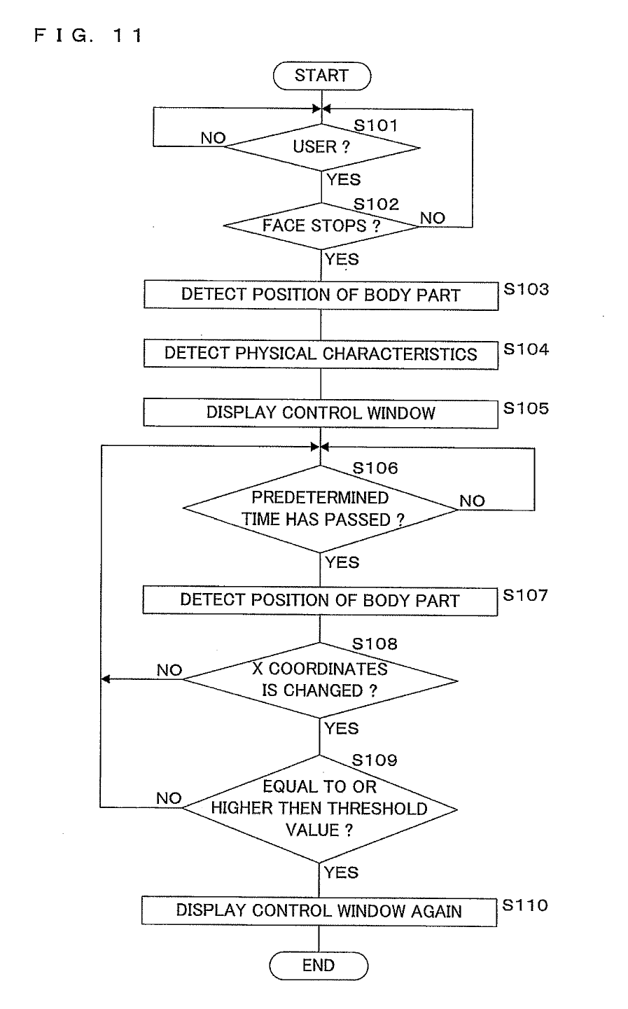

FIG. 11 is a flow chart for explaining a display process of a control window W in the large-sized display apparatus 100 according to Embodiment 2 of the present invention.

The image pickup section 11 picks up an image in front of the display section 2, and based on the image picked up by the image pickup section 11, the judging section 13 judges whether or not a user is within a predetermined anterior distance from the display section 2 and within a predetermined area in the width direction of the display section 2 (S101). The judgment by the judging section 13 is performed as described above, and detailed explanations thereof will be omitted.

When the judging section 13 judges that the user is not within the predetermined anterior distance from the display section 2 and within the predetermined area in the width direction of the display section 2 (S101: NO), the CPU 1 holds it.

On the other hand, when the judging section 13 judges that the user is within the predetermined anterior distance from the display section 2 and within the predetermined area in the width direction of the display section 2 (S101: YES), the CPU 1 judges whether or not the user's face looks toward the display section 2 (display screen 21) and stops for a predetermined time, based on the image picked up by the image pickup section 11 and a clocking result of the clock section 8 (S102).

When the CPU 1 judges that the user's face does not stop for the predetermined time (S102: NO), it returns the process to S101. On the other hand, when the CPU 1 judges that the user's face stops for the predetermined time (S102: YES), it gives an instruction for the body detecting section 12 to detect a position of a specific body part of the user.

The body detecting section 12 detects a position of the specific body part of the user, based on the image picked up by the image pickup section 11 according to the instruction of the CPU 1 (S103). In detail, as mentioned above, a position of a face of the user is detected and the detection of the position of the face by the body detecting section 12 is performed as described above, and detailed explanations thereof will be omitted. The RAM 6 stores coordinates indicating the position on the display section 2 corresponding to the detected position of the user's face.

Subsequently, the physical-characteristics detecting section 10 detects physical characteristics of the user, based on the image picked up by the image pickup section 11 (S104). In detail, the physical-characteristics detecting section 10 estimates age, sex, etc. of the user. The estimation of age, sex, etc. of the user by the physical-characteristics detecting section 10 is performed as described above, and detailed explanations thereof will be omitted.

Moreover, the display control section 3 causes the display section 2 to display a control window W, based on processing results by the body detecting section 12 and the physical-characteristics detecting section 10 (S105). The display of a control window W by the display section 2 according to the instruction of the display control section 3 based on processing results of the body detecting section 12 and the physical-characteristics detecting section 10 is described above, and detailed explanations thereof will be omitted.

Subsequently, the CPU 1 gives an instruction for the clock section 8 to start clocking. The clock section 8 starts clocking according to the instruction of the CPU 1. The CPU 1 judges whether or not a predetermined time has passed since a display start of the control window W, based on a clocking result of the clock section 8 (S106).

When the CPU 1 judges that the predetermined time has not passed yet since the display of the control window W started (S106: NO), it stands by until the predetermined time passes.

On the other hand, when the CPU 1 judges that the predetermined time has passed from the display of the control window W (S106: YES), it gives an instruction for the body detecting section 12 to detect a position of a specific body part of the user.

According to the instruction of the CPU 1, the body detecting section 12 detects the position of the specific body part of the user again, based on the image picked up by the image pickup section 11 at that time (S107). That is, as mentioned above, the body detecting section 12 detects a position of the user's face, and the RAM 6 stores coordinates showing the detected position of the user's face.

The CPU 1 compares the coordinates corresponding to the position of the user's face detected last time (S103) with the coordinates corresponding to the position of the user's face detected this time (S107) to judge whether or not the X coordinates of the two coordinates differ from each other (S108).

When the CPU 1 judges that the X coordinates do not differ from each other (S108: NO), it returns the process to S106 and gives an instruction for the clock section 8 to start clocking.

On the other hand, when the CPU 1 judges that the X coordinates differ from each other (S108: YES), it judges whether or not the variation in X coordinates is equal to or higher than a predetermined threshold value (S109). The threshold value is set to a value equivalent to an actual distance of 50 cm, for example.

When the CPU 1 judges that the variation in X coordinates is not equal to or higher than the predetermined threshold value (S109: NO), it returns the process to S106 and gives an instruction for the clock section 8 to start clocking. On the other hand, when the CPU 1 judges that the variation in X coordinates is equal to or higher than the predetermined threshold value (S109: YES), it gives an instruction for the display control section 3 to cause the display section 2 to display the control window W again, based on the position of the user's face detected newly this time (S107).

According to the instruction of the CPU 1, the display control section 3 causes the display section 2 to delete the currently displayed control window W and to display the control window W again, based on the position of the user's face detected newly (S110).

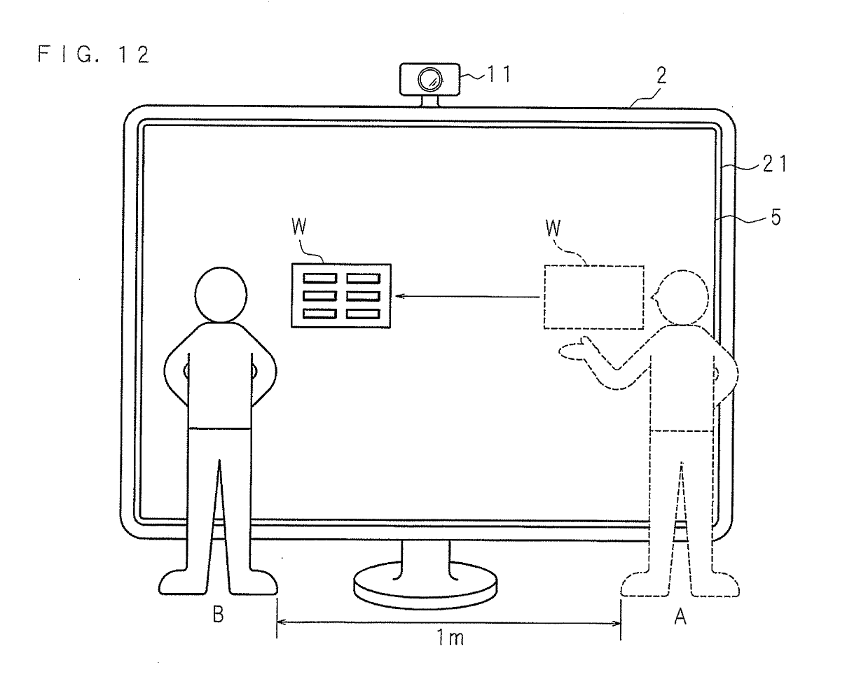

Therefore, the large-sized display apparatus 100 according to Embodiment 2 of the present invention can respond even though a user moves. FIG. 12 is an explanatory diagram for explaining a display of a control window W corresponding to a user's movement in the large-sized display apparatus 100 according to Embodiment 2 of the present invention. For convenience of description, the following description will explain an example in which a user makes a presentation using the large-sized display apparatus 100, and the physical-characteristics detecting section 10 estimates that the user is male aged 50 or less.

For example, suppose that a control window W is displayed when a user is at the A position, and then, the user moves to the B position about 1 m away in the width direction of the large-sized display apparatus 100. When a predetermined time has passed from the display of the control window W, the body detecting section 12 detects a position of a face of the user who is at the B position.

Since the user moves for a predetermined distance, the CPU 1 judges that the X coordinates corresponding to the position of the user's face changed. And because the variation in X coordinates corresponding to the positions of the user's face is equal to the predetermined threshold value, the display control section 3 causes the display section 2 to display the control window W again, based on the position of the user's face detected newly at the B position.

Therefore, it is possible to prevent beforehand a disadvantage of an operation occurring when a user cannot reach to the control window W due to the transference of the user, and enhance the convenience of a user at a time of the operation.

The same parts as in Embodiment 1 are designated with the same reference numbers, and detailed explanations thereof will be omitted.

### Embodiment 3

The Following Description Will Explain a Large-Sized Display apparatus 100 according to Embodiment 3 of the present invention, based on the drawings in detail.

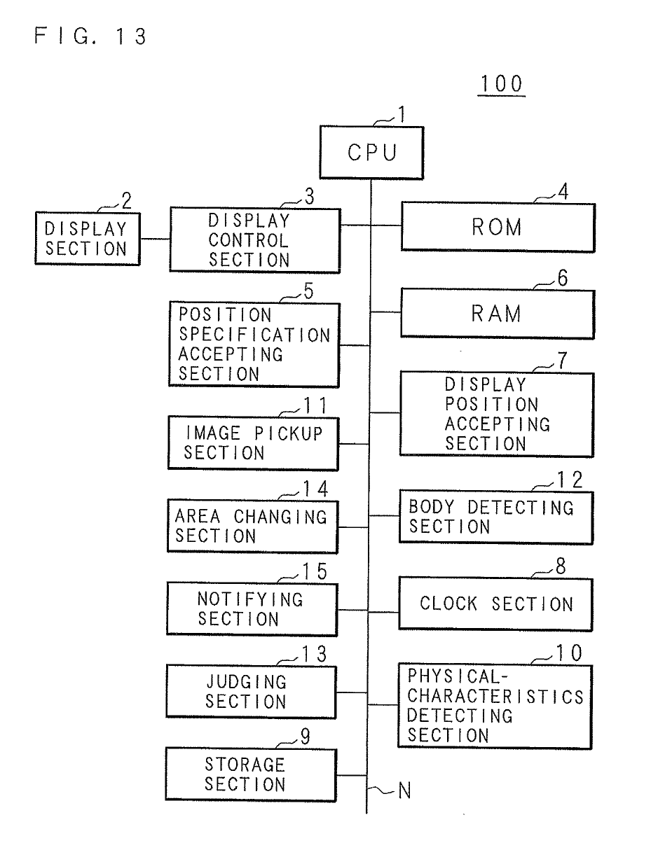

FIG. 13 is a functional block diagram showing essential configurations of a large-sized display apparatus 100 according to Embodiment 3 of the present invention. The large-sized display apparatus 100 according to Embodiment 3 further comprises an area changing section 14 and a notifying section 15, in addition to the large-sized display apparatus 100 according to Embodiment 2.

In the large-sized display apparatus 100 according to Embodiment 3 of the present invention, the position specification accepting section 5 is configured so as to accept a position specification in a predetermined area of the display screen 21 of the display section 2.

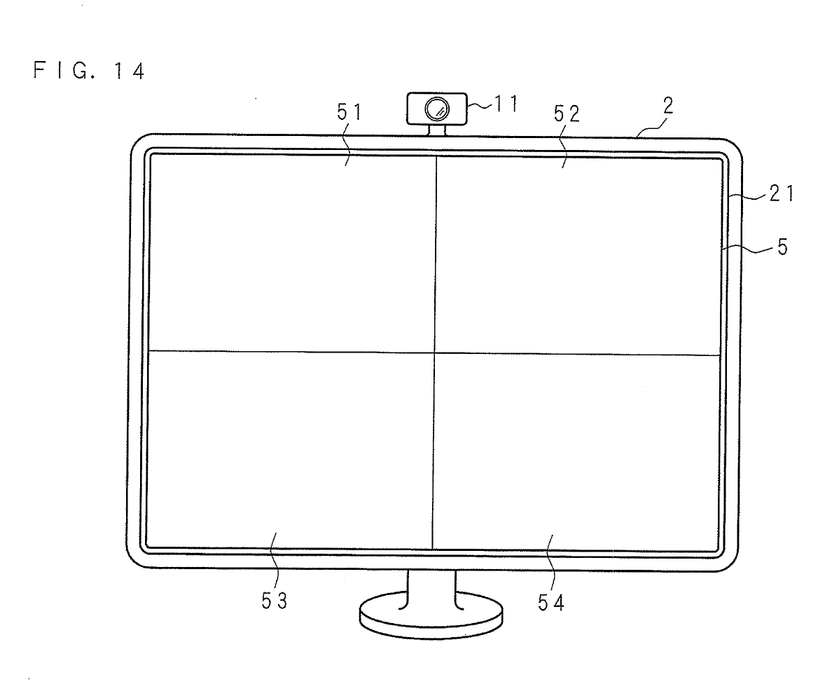

In detail, the position specification accepting section 5 of the large-sized display apparatus 100 of Embodiment 3 of the present invention can be partially turned on and off. That is, only a part of the position specification accepting section 5 of the large-sized display apparatus 100 of Embodiment 3 of the present invention is turned on if necessary, and the position specification accepting section 5 of Embodiment 3 is configured so as to accept a touch operation (position specification) of a user with respect to only an image in a predetermined area of the display screen 21 corresponding to the part of the position specification accepting section 5. The following description will explain an example in which the position specification accepting section 5 has four sub-position specification accepting sections 51, 52, 53, 54, as shown in FIG. 14, and only any one or a plurality of the sub-position specification accepting sections accept a position specification if necessary.

The area changing section 14 changes an area to be turned on for accepting a position specification in the position specification accepting section 5. That is, the area changing section 14 controls electrically the sub-position specification accepting sections 51, 52, 53, 54, and thereby only any one or a plurality of the sub-position specification accepting sections are turned on and only the sub-position specification accepting section turned on can accept a position specification. Therefore, a predetermined area of the display screen 21 for accepting a position specification from a user is also changed.

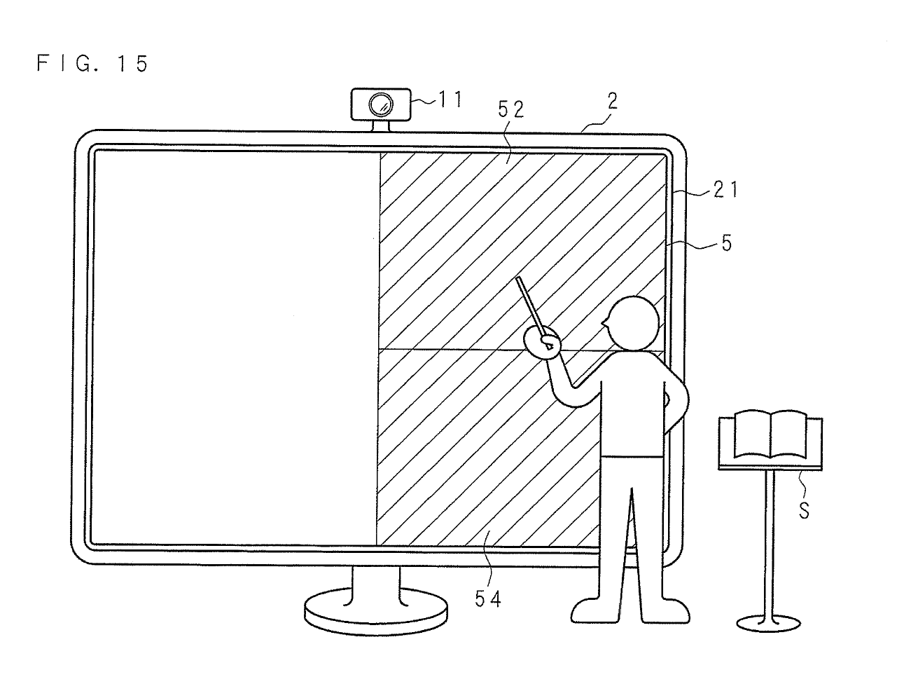

FIG. 15 is an exemplary view showing an example of a changing process of a part, capable of accepting a position specification, of the position specification accepting section 5 of the large-sized display apparatus 100 according to Embodiment 3 of the present invention.

For example, when the large-sized display apparatus 100 according to Embodiment 3 of the present invention is used for presentation, a document table S is located on a left side or a right side of the large-sized display apparatus 100. Therefore, it can be expected that a position of a user (presenter) is fixed to the left side or the right side of the large-sized display apparatus 100. In this case, by the area changing section 14, only the sub-position specification accepting sections 52, 54 can be turned on and the sub-position specification accepting sections 51, 53 can be turned off. Therefore, the large-sized display apparatus 100 according to Embodiment 3 of the present invention allows reduction of the operation cost.

On the other hand, when a position specification on the display screen 21 of the display section 2 is selectively accepted in a predetermined area on the display screen 21 of the display section 2, as described above, that is, when only any one or a plurality of the sub-position specification accepting sections are an ON-state among the sub-position specification accepting sections 51, 52, 53, 54, it is extremely difficult to judge which sub-position specification accepting section is currently an ON-state with the naked eye. Then, the notifying section 15 notifies a sub-position specification accepting section which is currently an ON-state. In other words, the notifying section 15 notifies a user of information indicating an area on the display screen 21 of the display section 2 corresponding to the sub-position specification accepting section which can accept a position specification currently.

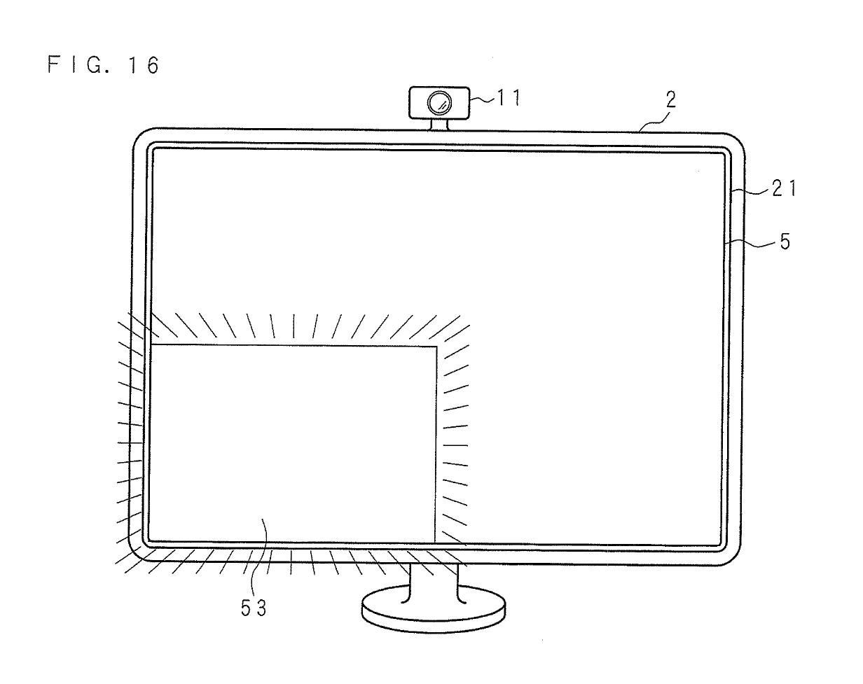

FIG. 16 is an exemplary view for explaining the notification in the large-sized display apparatus 100 according to Embodiment 3 of the present invention. For example, suppose that only the sub-position specification accepting section 53 is turned on by the area changing section 14.

In this case, the notifying section 15 notifies a user of information indicating that a sub-position specification accepting section which is currently an ON state is the sub-position specification accepting section 53. That is, the notifying section 15 notifies a user that it is possible to accept currently a touch operation (position specification) of an image displayed in an area on the display screen 21 of the display section 2 corresponding to the sub-position specification accepting section 53 only (hereinafter referred to as corresponding area). As a notifying method, for example, the notifying section 15 notifies such information by changing lightness of a partial image to be displayed in the corresponding area on the display screen 21 of the display section 2 so as to be higher than that of the other part. Moreover, the present invention is not limited to this, and it may be configured such that an image concerning the corresponding area is displayed in a blinking condition.

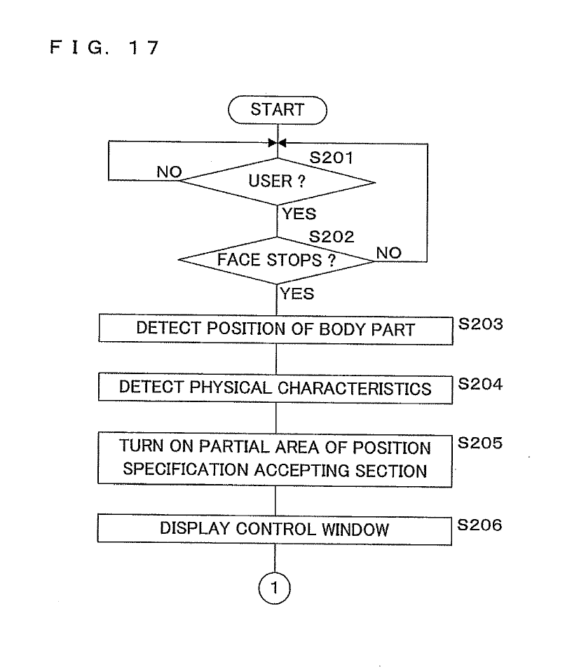

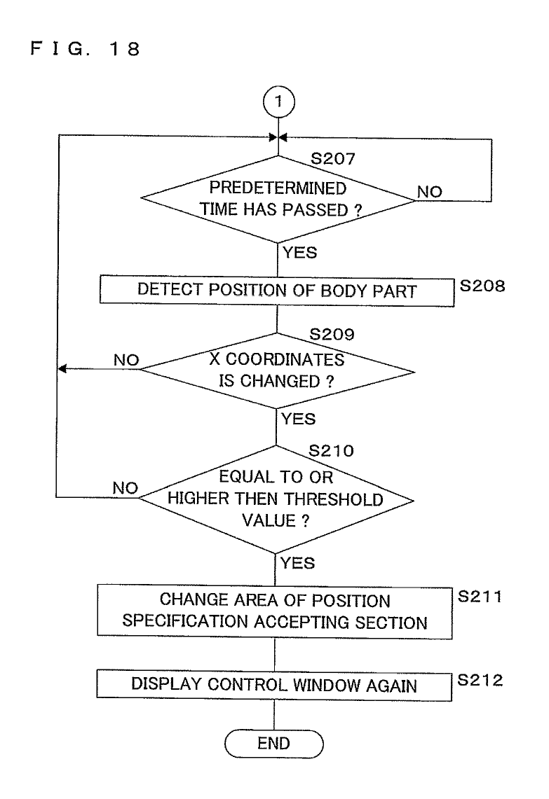

FIGS. 17 and 18 are flow charts for explaining a display process of a control window W in the large-sized display apparatus 100 according to Embodiment 3 of the present invention. The following description will explain an example in which the position specification accepting section 5 has four sub-position specification accepting sections 51, 52, 53, 54, and only any one or a plurality of sub-position specification accepting sections accept a position specification if necessary, as described above.

The judging section 13 judges whether or not a user is within the predetermined anterior distance from the display section 2 and within the predetermined area in the width direction of the display section 2, based on the image picked up by the image pickup section 11 (S201). The judgment by the judging section 13 is performed as described above, and detailed explanations thereof will be omitted.

When the judging section 13 judges that the user is not within the predetermined anterior distance from the display section 2 and within the predetermined area in the width direction of the display section 2 (S201: NO), the CPU 1 holds it.

On the other hand, when the judging section 13 judges that the user is within the predetermined anterior distance from the display section 2 and within the predetermined area in the width direction of the display section 2 (S201: YES), the CPU 1 judges whether or not the user's face looks toward the display section 2 (display screen 21) and stops for a predetermined time, based on the image picked up by the image pickup section 11 and a clocking result of the clock section 8 (S202).

When the CPU 1 judges that the user's face does not stop for the predetermined time (S202: NO), it return the process to S201. On the other hand, when the CPU 1 judges that the user's face stops for the predetermined time (S202: YES), the body detecting section 12 detects a position of the specific body part of the user, based on the image picked up by the image pickup section 11 (S203). In detail, as mentioned above, a position of a face of the user is detected and the detection of the position of the face by the body detecting section 12 is performed as described above, and detailed explanations thereof will be omitted. At this time, the RAM 6 stores coordinates indicating the position on the display section 2 corresponding to the detected position of the user's face.

Subsequently, the physical-characteristics detecting section 10 detects physical characteristics of the user, based on the image picked up by the image pickup section 11 (S204). In detail, the physical-characteristics detecting section 10 estimates age, sex, etc. of the user. The estimation of age, sex, etc. of the user by the physical-characteristics detecting section 10 is performed as described above, and detailed explanations thereof will be omitted.

The CPU 1 determines which sub-position specification accepting section should be turned on, based on the coordinates concerning the position of the user's face stored in the RAM 6, and it gives an instruction for the area changing section 14 to turn on a predetermined sub-position specification accepting section based on a determination result. For example, the CPU 1 compares the X coordinate of the coordinates concerning a position of a user's face with the X coordinate indicating the center of the display section 2. When the CPU 1 judges that the X coordinate of the coordinates corresponding to the position of the user's face is slanted toward a right side (shown in the drawing) from the center of the display section 2, the CPU 1 determines that the sub-position specification accepting sections 52, 54 located on the right side of the display section 2 should be turned on, and gives an instruction for the area changing section 14 to turn on them.

On the other hand, when the CPU 1 judges that the X coordinate of the coordinates corresponding to the position of the user's face is slanted toward a left side (shown in the drawing) from the center of the display section 2, the CPU 1 determines that the sub-position specification accepting sections 51, 53 located on the left side of the display section 2 should be turned on, and gives an instruction for the area changing section 14 to turn on them.

The area changing section 14 turns on only a partial area of the position specification accepting section 5 according to the instruction of the CPU 1 (S205). For example, in the above-mentioned case, the area changing section 14 turns on only the sub-position specification accepting sections 52, 54, or turns on only the sub-position specification accepting sections 51, 53.

Subsequently, the display control section 3 causes the display section 2 to display a control window W based on processing results by the body detecting section 12 and the physical-characteristics detecting section 10 (S206). The display of a control window W by the display section 2 according to the instruction of the display control section 3 based on processing results of the body detecting section 12 and the physical-characteristics detecting section 10 is described above, and detailed explanations thereof will be omitted.

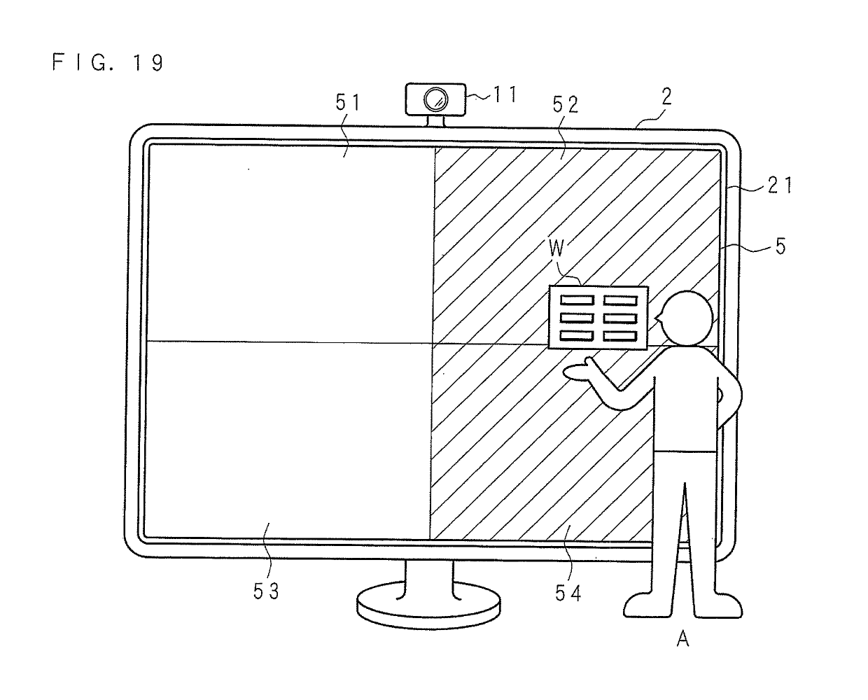

FIG. 19 is an exemplary view showing processing results from S201 to S206 in Embodiment 3 of the present invention.

For example, when the CPU 1 judges that the X coordinate of the coordinates corresponding to the position of the user's face is slanted toward the right side (shown in the drawing) from the center of the display section 2, the CPU 1 determines that the sub-position specification accepting sections 52, 54 located on the right side of the display section 2 should be turned on. The area changing section 14 turns on the sub-position specification accepting sections 52, 54, and turns off the sub-position specification accepting sections 51, 53, according to the instruction of the CPU 1. Moreover, the display control section 3 causes the display section 2 to display a control window W at a corresponding area on the display screen 21 of the display section 2 corresponding to the sub-position specification accepting sections 52, 54, based on the processing results of the body detecting section 12 and the physical-characteristics detecting section 10. In this case, since the sub-position specification accepting sections 52, 54 are an ON-state, they can accept a position specification from the touch operation of the control window W by the user.

Subsequently, the CPU 1 gives an instruction for the clock section 8 to start clocking. The clock section 8 starts clocking according to the instruction of the CPU 1. The CPU 1 judges whether or not a predetermined time has passed since a display start of the control window W, based on a clocking result of the clock section 8 (S207).

When the CPU 1 judges that the predetermined time has not passed yet since the display of the control window W started (S207: NO), it stands by until the predetermined time passes. On the other hand, when the CPU 1 judges that the predetermined time has passed from the display of the control window W (S207: YES), the body detecting section 12 detects the position of the specific body part of the user again, based on the image picked up by the image pickup section 11 at that time (S208). That is, as mentioned above, the body detecting section 12 detects a position of the user's face, and the RAM 6 stores coordinates indicating a position on the display section 2 corresponding to the detected position of the user's face.

The CPU 1 compares the coordinates corresponding to the position of the user's face detected last time (S203) with the coordinates corresponding to the position of the user's face detected this time (S208) to judge whether or not the X coordinates of the two coordinates differ from each other (S209).

When the CPU 1 judges that the X coordinates do not differ from each other (S209: NO), it returns the process to S207 and gives an instruction for the clock section 8 to start clocking. On the other hand, when the CPU 1 judges that the X coordinates differ from each other (S209: YES), it judges whether or not the variation in X coordinates is equal to or higher than a predetermined threshold value (S210). The threshold value is set to a value equivalent to an actual distance of 50 cm, for example.

When the CPU 1 judges that the variation in X coordinates is not equal to or higher than the predetermined threshold value (S210: NO), it returns the process to S207 and gives an instruction for the clock section 8 to start clocking. On the other hand, when the CPU 1 judges that the variation in X coordinates is equal to or higher than the predetermined threshold value (S210: YES), it determines which sub-position specification accepting section should be turned on again.

The CPU 1 determines which sub-position specification accepting section should be turned on, based on the coordinate corresponding to the position of the user's face detected at S208. The determination by the CPU 1 is described above, and detailed explanations thereof will be omitted. The CPU 1 gives an instruction for the area changing section 14 to turn on a predetermined sub-position specification accepting section, according to a determination result. The area changing section 14 turns on only a partial area of the position specification accepting section 5 according to the instruction of the CPU 1, to change an area (S211).

Subsequently, the display control section 3 causes the display section 2 to delete the currently displayed control window W and to display the control window W again (S212), based on the position of the user's face detected newly at this time (S208).

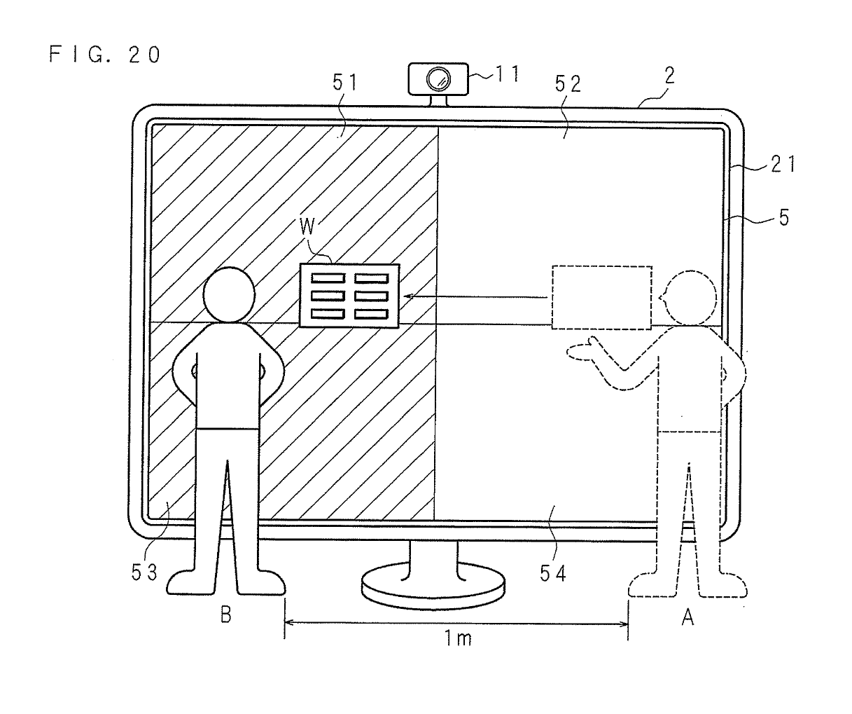

FIG. 20 is an exemplary view showing processing results from S207 to S212 in Embodiment 3. For example, suppose that, as shown in FIG. 19, a control window W is displayed when a user is at the A position, and then, the user moves to the B position about 1 m away in the width direction of the large-sized display apparatus 100. When a predetermined time has passed from the display of the control window W, the body detecting section 12 detects a position of a face of the user who is at the B position.

For example, since the X coordinate of the coordinates corresponding to the position of the face of the user being at the B position is slanted toward the left side (shown in the drawing) from the center of the display section 2, the CPU 1 determines that the sub-position specification accepting sections 51, 53 located on the left side of the display section 2 should be turned on. The area changing section 14 turns on the sub-position specification accepting sections 51, 53, and turns off the sub-position specification accepting sections 52, 54, according to the instruction of the CPU 1.

Since the user moves for a predetermined distance, the CPU 1 judges that the X coordinates corresponding to the position of the user's face is changed. And because the variation in X coordinates corresponding to the positions of the user's face is higher than a predetermined threshold value, and the display control section 3 causes the display section 2 to display the control window W again, based on the position of the user's face detected newly at the B position. That is, the display control section 3 causes the display section 2 to display the control window W again at the corresponding area on the display screen 21 of the display section 2 corresponding to the sub-position specification accepting sections 51, 53. In this case, since the sub-position specification accepting sections 51, 53 are ON-state, they can accept a position specification from the touch operation of the control window W by the user.

Therefore, it is possible to prevent beforehand a disadvantage of an operation occurring when a user cannot reach to the control window W due to the transference of the user and enhance the convenience of a user at a time of the operation, in the large-sized display apparatus 100 of Embodiment 3 of the present invention.

Moreover, in the large-sized display apparatus 100 of Embodiment 3 of the present invention, a part of the sub-position specification accepting sections which is not used actually is turned off, thereby allowing the cost reduction.

The same parts as in Embodiment 1 are designated with the same reference numbers, and detailed explanations thereof will be omitted.

The large-sized display apparatus 100 according to the present invention is not limited to the above-described configuration. For example, the display section 2 may be configured so as to be a so-called multi-display comprising a plurality of sub-display sections. In this case, the area changing section 14 may be configured so as to control the turning on and off of the position specification accepting section of each sub-display section. Note that, in this case, the area changing section 14 needs to comprise a scaling section and assign an image to each sub-display section.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

What is claimed is:

1. A display apparatus, comprising:
a display section for displaying an image;
a display control section for causing the display section to display an instruction acceptance image for accepting an instruction concerning display of the image;
a position specification accepting section for accepting a position specification on a display screen of the display section; and
a display position accepting section for accepting a specification of a display position of the instruction acceptance image via the position specification accepting section.

2. The display apparatus according to claim 1, wherein
the display control section causes the display section to display one or a plurality of instruction acceptance images.

3. The display apparatus according to claim 1, wherein
the position specification accepting section accepts a position specification in a predetermined area on the display screen of the display section, and
the display control section causes the display section to display the instruction acceptance image in the predetermined area.

4. The display apparatus according to claim 3, further comprising an area changing section for changing the predetermined area.

5. The display apparatus according to claim 3, further comprising a notifying section for notifying information indicating the predetermined area.

6. The display apparatus according to claim 1, further comprising an image pickup section for picking up an image in front of the display section, wherein
based on the image picked up by the image pickup section, the display control section causes the display section to display the instruction acceptance image.

7. The display apparatus according to claim 6, further comprising a body detecting section for detecting a position of a specific body part of a user, based on the image picked up by the image pickup section, wherein
the display control section changes the display position of the instruction acceptance image, based on a detection result of the body detecting section.

8. The display apparatus according to claim 6, further comprising a characteristics detecting section for detecting physical characteristics of a user, based on the image picked up by the image pickup section, wherein
the display control section changes a constitution of the instruction acceptance image, based on a detection result of the characteristics detecting section.

9. The display apparatus according to claim 6, further comprising a judging section for judging existence of a user in a predetermined area based on the image picked up by the image pickup section, wherein
the display control section causes the display section to display the instruction acceptance image based on a judgment result of the judging section.

10. The display apparatus according to claim 7, wherein
the body detecting section detects a position of a specific body part of a user at a predetermined time interval.

11. The display apparatus according to claim 7, further comprising an area changing section for changing the predetermined area, wherein
the area changing section changes a predetermined area of the display screen of the display section, based on a detection result of the body detecting section.

12. The display apparatus according to claim 3, wherein
the display section includes a plurality of sub-display sections, and
a part of the sub-display sections has the position specification accepting section.

13. A display method with a display apparatus comprising; a display section for displaying an image; a display control section for causing the display section to display an instruction acceptance image for accepting an instruction concerning display of the image; and a position specification accepting section for accepting a position specification on a display screen of the display section, the display method for displaying the instruction acceptance image, comprising:
a display position acceptance step for accepting a specification of a display position of the instruction acceptance image via the position specification accepting section; and
a step for causing the display section to display the instruction acceptance image by the display control section, based on the display position accepted at the display position acceptance step.
